(19) United States
(12) Patent Application Publication
(10) Pub. No.: US 2013/0182098 A1
(43) Pub. Date: Jul. 18, 2013

(54) Downhole Digital Survey Camera

(71) Applicants: Rick Duncan, Magnolia, TX (US); Kevin Clift, Montogmery, TX (US)

(72) Inventors: Rick Duncan, Magnolia, TX (US); Kevin Clift, Montogmery, TX (US)

(73) Assignee: Multi-Shot, LLC

(21) Appl. No.: 13/350,353

(22) Filed: Jan. 13, 2012

(51) Int. Cl. H04N 7/18

(52) U.S. Cl. 348/85; 348/E07.085

(57) ABSTRACT

A digital camera surveying system and method allows digital images of other surveying tools, such as an inclinometer and gyro compass, to be captured during surveying. The digital camera provides a protective housing securing a lens assembly and flash lap positioned to capture images of other surveying tools. Further, the protective housing may also provide an interface window that allows an operator to command operation of the digital camera and to connect external devices to the digital camera.

### FIELD OF THE INVENTION

This invention relates to a downhole digital survey tool. More particularly, to a photographic image acquisition and recording system.

### BACKGROUND OF INVENTION

Since the 1930s boreholes were drilled and surveyed with instruments that relied on photographic film. The survey tools would take an image of an inclination pendulum and gyro compass dial to record survey data. Borehole direction and slant angle information could be retrieved from the images and correlated with measured depths to compute the path of the borehole.

Photographic survey systems remain relatively inexpensive in comparison to newer technologies utilized in other survey tools. However, an operator must be extremely careful to avoid contaminating or pre-exposing the photographic film while preparing for and completing the survey. Survey failures due to mishandling or poor film processing are not uncommon. Further, resulting downtime for re-running borehole surveys adds to the cost of drilling. Survey failures due to mechanical and electromechanical failures of the photographic film cameras may also occur.

### SUMMARY OF THE INVENTION

In one implementation, a digital camera survey system includes a housing and a gyro compass with a rotatable member, wherein the gyro compass is utilized to determine a geographical direction. The system also includes components of a digital camera disposed within the housing, wherein the digital camera captures digital images of the gyro compass during surveying.

In another implementation, a method of surveying a borehole includes activating a digital camera survey system, and referencing on the surface a rotatable member of a gyro compass to determine a geographical direction. The digital camera surveying system is lowered into a borehole to survey the borehole, and a plurality of digital images of the gyro compass are captured.

The foregoing has outlined rather broadly various features of the present disclosure in order that the detailed description that follows may be better understood. Additional features and advantages of the disclosure will be described hereinafter.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 is an illustrative implementation of a digital survey system;

FIGS. 2A-2C are illustrative implementations of a top, side and exploded view of a digital camera;

FIG. 3A is an example image of a gyro compass; and

FIG. 3B is an example image of a inclinometer and gyro compass.

### DETAILED DESCRIPTION

Refer now to the drawings wherein depicted elements are not necessarily shown to scale and wherein like or similar elements are designated by the same reference numeral through the several views.

Referring to the drawings in general, it will be understood that the illustrations are for the purpose of describing particular implementations of the disclosure and are not intended to be limiting thereto. While most of the terms used herein will be recognizable to those of ordinary skill in the art, it should be understood that when not explicitly defined, terms should be interpreted as adopting a meaning presently accepted by those of ordinary skill in the art.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

Surveying may be conducted in a subterranean borehole to determine the path of the borehole. For example, a gyroscopic instrument, such as a gyro angle unit or gyro compass, whose performance in borehole surveying is dependent on supplemental information from a secondary sensor, such as a freely suspended inclination measuring pendulum over a calibrated ring glass, may be deployed to determine the path of the borehole. In prior surveying tools, the tools relied on photographic film to record gyroscopic and inclination image information. Borehole direction and slant angle information retrieved from the images could then be correlated to depth measurements to compute the path of the borehole. However, the use of photographic film presents several challenges, such as pre-exposure of the film, contamination of the film, mishandling the film, poor film processing, and the like. Such surveying failures may require downhole surveying to be re-run, and could consequently result in drilling down time thereby increasing operations cost.

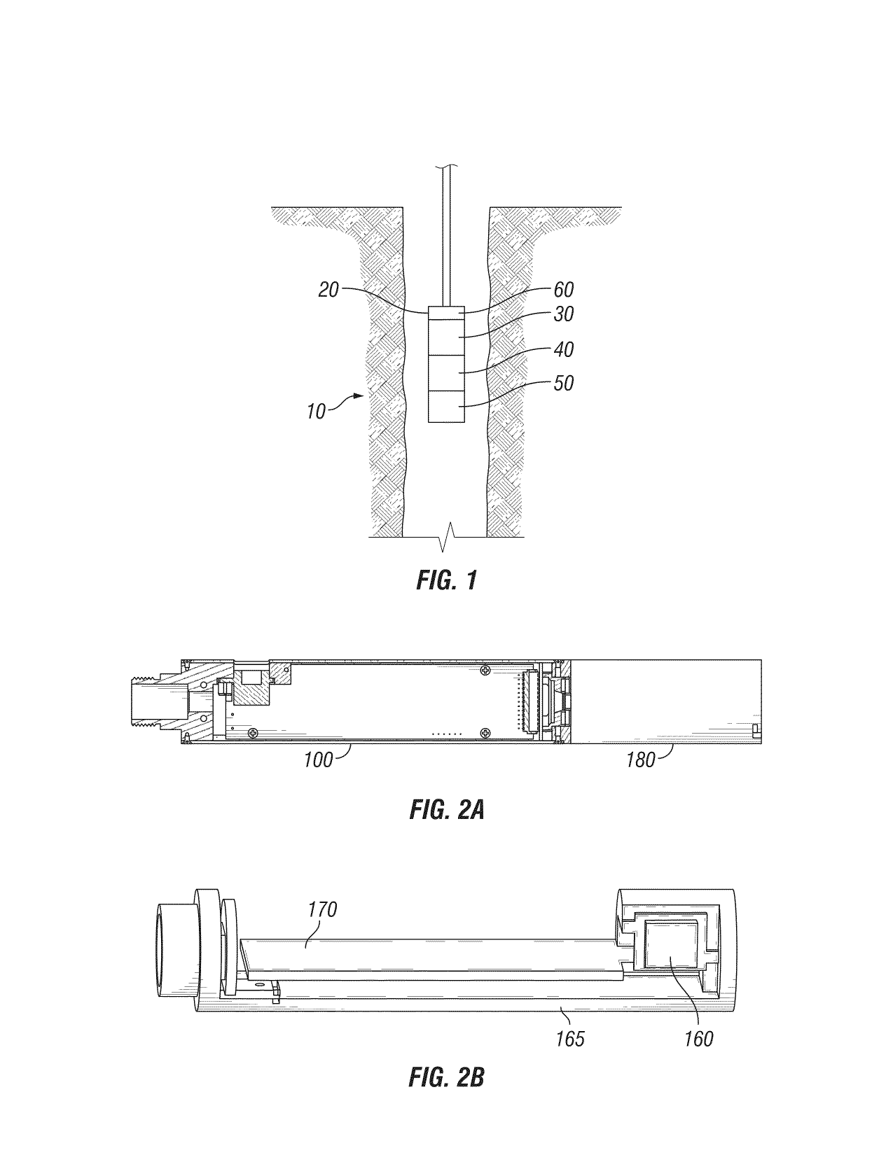

A downhole digital camera survey system and method discussed herein utilizes modern digital imaging and microprocessor technology to replace the photographic film camera used in conventional borehole surveying. FIG. 1 is an illustrative implementation of a digital survey system 10. Digital survey system 10 utilizes a housing 20 to secure a digital camera 30, inclinometer 40, gyroscopic unit 50, and depth measurement tool 60. The components of digital survey system 10 may be provided as separate units that are coupled together or may be combine into a single housing. Housing 20 provides a space in which components of the digital survey system 10 can be protected. Housing 20 may protect components from impact, wellbore and other fluids, high temperatures, and/or the like. Digital camera 30 is utilized to capture images of inclinometer 40 and gyroscopic unit 50 throughout a survey process. Inclinometer 40 allows the digital survey system 10 to measure inclination or angle. Inclinometers are well known in the art, and inclinometer 40 may be any suitable inclinometer utilized for inclination measurements, such as an inclination measuring pendulum. Gyroscopic unit 50 allows digital survey system 10 to measure wellbore direction. Gyroscopic units are well known in the art, and gyroscopic unit 50 may be any suitable gyroscopic unit for measuring direction, such as a gyro compass or gyro angle unit. Note that incline and directional measurement tools may be combined into a single system that may be suitable for digital survey system 10.

A depth measurement tool 60, such as a collar locator, may also be provided in the upper end of housing 20 of digital survey system for electric wireline access. Depth measurement tool 60 provides depth measurements. These depth measurements may be associated with the borehole direction and slant angle information provided by inclinometer 40 and gyroscopic unit 50 to map the path of the borehole. For example, depth measurements may be time synchronized with direction and slant angle information. Depth measurement tools are well known in the art. Any suitable type of depth measurement tool may be utilized, such as a depth measuring system described in U.S. Pat. No. 5,351,531, collar locator, and/or any other suitable depth measurement device.

Digital camera 30 captures images of inclinometer 40 and gyroscopic unit 50, including measurement scales of the devices, such as calibrated ring glass, gyro compass dial, vernier scale, and/or the like. Digital camera 30 may capture images at a predetermined interval, such as, but not limited to, every 15 seconds. The digital images captured are stored in a memory connected to or provide by digital camera 40.

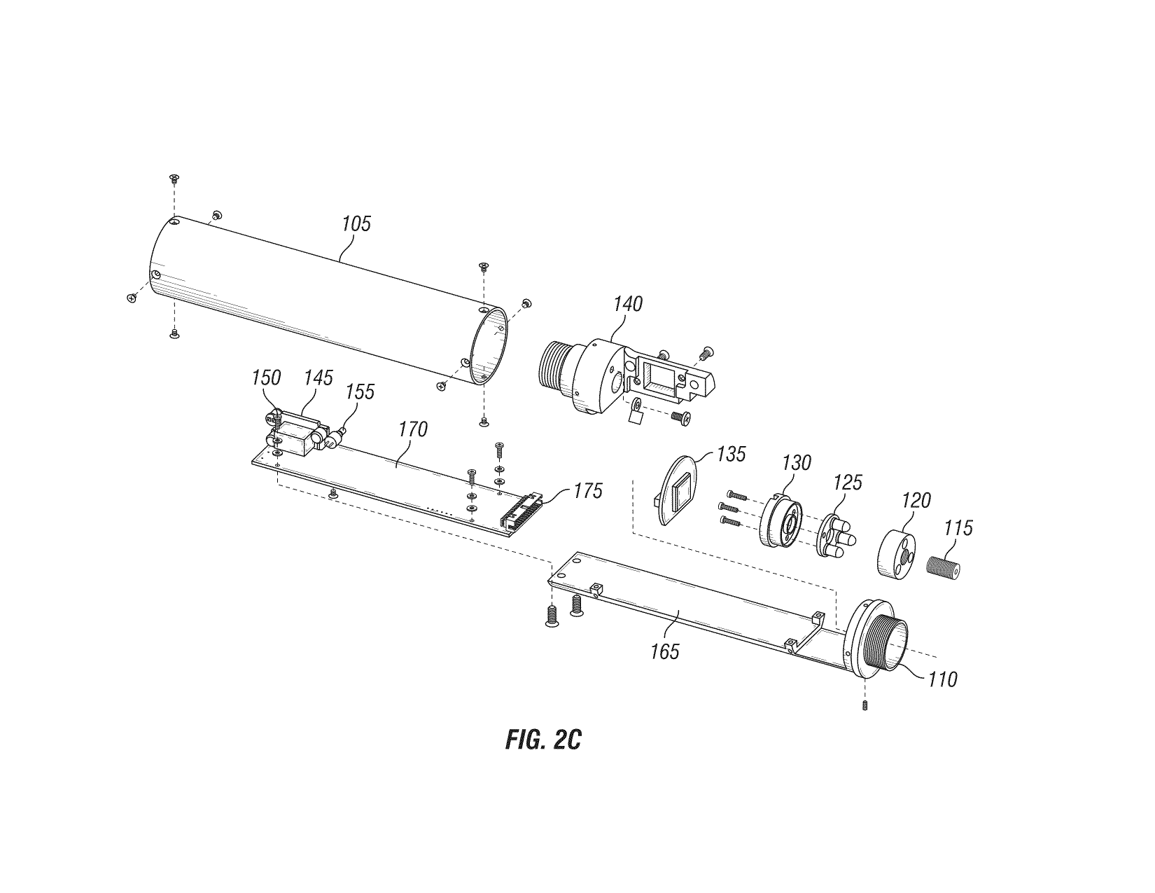

FIGS. 2A-2C are illustrative implementations of a top, side and exploded view of a digital camera 100. Digital camera 100 is provided in housing 105 securing the components of the digital camera. Housing 105 secures the components of digital camera 100 to prevent damage to the digital camera. A first end provides adapter 110, lens assembly 115, lamp and lens housing 120, lamp 125, spacer 130, and imaging PCB assembly 135.

Adapter 110 secures to one end of housing 105. Adapter 110 provides an opening for components of the camera assembly to allow digital images to be captured from a first end of digital camera 100. Adapter 100 may provide any suitable attachment means to allow digital camera 100 to be secured to a inclinometer, gyroscopic unit, depth measurement tool and/or other surveying tool, thereby allowing the digital camera to capture images of such components. For example, adapter 100 may provide threading or any suitable means know in the art for coupling surveying tools. Lens assembly 115 provides a lens and image capturing mechanism for digital camera 100. For example, the image capturing mechanism may comprise at least a charge coupled device (CCD) or any other suitable imaging capturing components. Digital camera 100 may also provide an Lamp 125 utilized to provide a flash or illuminated an item to be photographed, such as an inclinometer, gyro compass, or the like. Lamp 125 may provide one or more light source, such as, but not limited to light emitting diodes (LEDs), flashbulbs, light bulbs, or the like. Lens assembly 115 and lamp 125 are secured to lamp and lens housing 120. Lens assembly 115 and lamp 125 may be secured to lamp and lens housing 120 by any suitable means. For example, lens assembly 115 may be threadably coupled to lamp and lens housing 120, and lamp 125 may be secured to lamp and lens housing 120 using fasteners, such as screws. Digital camera 100 may provide a spacer 130 to firmly secure camera components in place or to prevent undesirable movement of camera component. Imaging PCB assembly 135 may be coupled lens assembly 115. Imaging PCB assembly 135 may provide hardware and/or software for image processing of images captured by lens assembly 115.

The opposite end of digital camera 100 may provide a interface mount 140, interface assembly 145, LED indicator 150, and switch 155. Interface mount 140 may provide a mount for any interfaces or indicators provided by digital camera 100. Interface assembly 145 provides one or more interfaces that allow external devices to be connected to digital camera 100. For example, interface assembly 145 may provide USB hardware, firewire or IEEE 1394 hardware, wireless communication hardware, Bluetooth communication hardware, or the like to allow data, such as digital images and other data, to be downloaded from digital camera 100. The external device may be utilized to download and view the digital images. Further, the external device may be utilized analyze the digital images to produce slant angle, borehole direction data, and/or a borehole pathway report. For example, the external device may be a computer, laptop, handheld device, PDA, cell phone, tablet computer, or any suitable data processing device. An LED indicator 150 may be provided to indicate whether digital camera 100 is off or on. Further, LED indicator 150 may flash when a digital image is capture. Switch 155 may be coupled to interface mount 140 to allow an operator to turn digital camera off or on. A protective window 160 may be provided in housing 105 to provide access to interface assembly 145 and switch 155, and the window 160 may also allow an operator to view LED indicator 150.

Chassis 165 provides a base for support the various camera components. Chassis 165 may be secured to adapter 110 and interface mount 140. Digital camera motherboard PCB 170 provides a base for interface assembly 145, LED indicator 150, and switch 155. Further, digital camera motherboard PCB 170 may provide connector 175 that may be coupled to imaging PCB assembly 135 to interface with lens assembly 115 and lamp 125. Digital camera motherboard PCB 170 is also electrically coupled to the various electronic components of digital camera 100. For example, digital camera motherboard PCB 170 may also be electronically coupled to interface assembly 145, LED indicator 150, and switch 155. Digital camera motherboard PCB 170 may provide additional components for digital camera 100 that are utilized for controlling, processing data, powering, storing data, transferring data, and the like. For example, digital camera motherboard PCB 170 may include a microprocessor, memory, power supply, wireless communication components, and/or the like, but is not specifically limited to these components. The memory may provide data storage for digital images and software. The memory may be non-volatile memory, such as, but not limited to, flash memory, memory cards, USB memory, electrically erasable memory, or the like. The power supply provides power to digital camera 100. The power supply may be rechargeable batteries, non-rechargeable batteries, or any other suitable power supply. The microprocessor may provide control and processing for digital camera 100. For example, microprocessor may control image capturing at a predetermined interval; camera flash operation; data transfer and storage; and/or the various features of digital camera 100 discussed herein. Further, microprocessor may provide digital signal processing, data compression, or the like for the digital image data. In other implementations, one or more of such components may be provided separately from digital camera motherboard PCB 170 and electronically coupled to digital camera motherboard PCB 170. For example, the power supply may be a battery pack separate from digital camera 100 that may be coupled to digital camera motherboard PCB 170 via a connector.

Digital camera 100 may be coupled to may be coupled to a secondary housing 180. Secondary housing 180 may provide a pendulum, gyroscopic unit, and depth measurement tool. An imaging sensor, provided by lens assembly 115, is controlled by a microprocessor, provided by digital camera motherboard PCB 170, to acquires images every fifteen seconds, and digitally stores those images in memory. By having the imaging sensor and microprocessor electronics housed together as a digital camera surveying system, digital camera 100 may capture while surveying inside the borehole, images of the inclination measuring pendulum, the gyrocompass dial, and/or vernier scale. Digital camera 100 operates continuously while surveying into and/or out of the borehole.

Once digital camera 100 is retrieved from the borehole, protective window or cover 160 may be removed and an external device, such as a computer or the like, may be connected to digital camera via interface assembly 145 for downloading and viewing the stored images. The computer may be utilized to assist interpretation of the images and to produce slant angle and borehole direction information at each surveyed depth. Angle and direction data may be subsequently processed by the computer to produce a borehole pathway survey report.

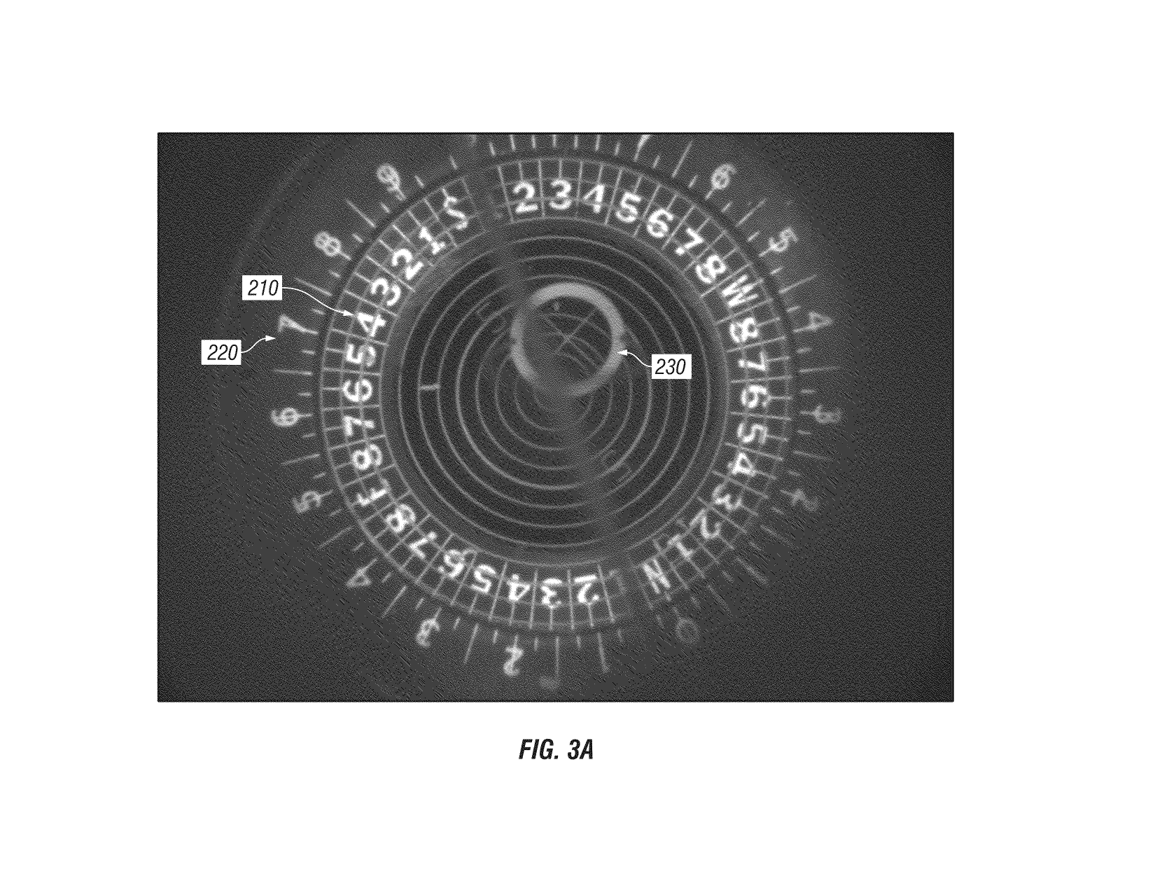

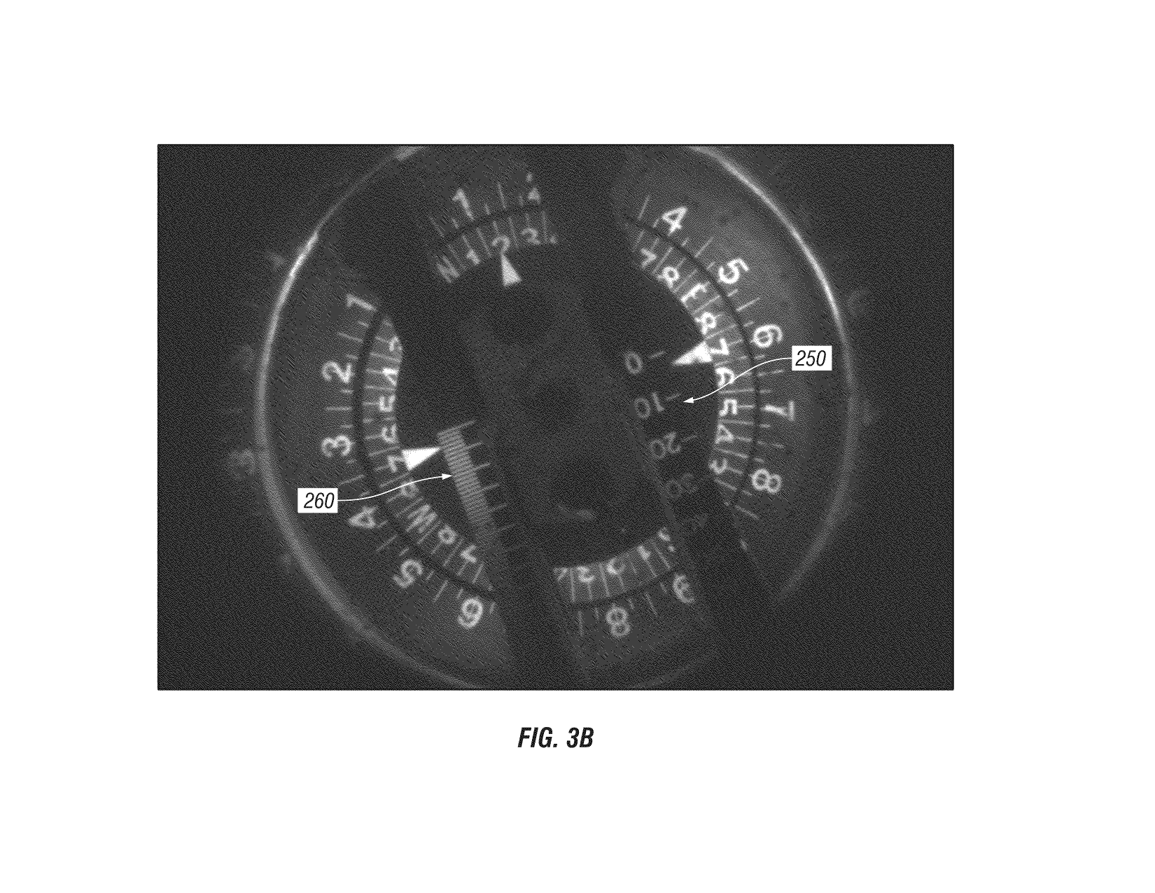

FIGS. 3A-3B provides an example of images that may be captured by digital camera surveying system. FIG. 3A is an example image of a gyro compass. A geographical direction scale 210 provides geographical direction information. Geographical direction scale 210 north, south, east, and west headings, as in a traditional compass. However, unlike magnetic compasses, a gyro compass can indicate true north without being effected by a magnetic field or ferromagnetic materials. Vernier scale 220 provides a second scale surrounding the circumference of a gyro compass. It is well know in the art that a vernier scale provides allows directional measurements to be read more precisely. An inclination and directional indicator or plumbob 230 provides inclination and direction information. Plumbob 230 may be an inclination and/or direction indicating pendulum. FIG. 3B is an example image of a inclinometer and gyro compass. An inclinometer may be positioned above a gyro compass to allow images of the inclinometer and gyro compass to viewed in a single image. An inclinometer scale 250 provides an incline reading. A vernier scale 260 for incline may also be provide to provide a more precise incline reading.

In addition to eliminating the risk of photographic film handling and processing failures, the downhole digital survey camera system also provides a novel means to acquire necessary survey information without stopping at the customarily prescribed station depths inside the borehole. The digital camera's extremely fast image capturing capability provides very clear and legible survey data. The digital camera accomplishes continuous surveying inside the borehole in conjunction with a suitable depth measurement tool. For example, a suitable depth measurement tool is described in U.S. Pat. No. 5,351,531. Digital camera 100 is time synchronized with the depth measurement tool to associate the digital images with the depth measurements.

This method of non-stop surveying increases borehole drilling efficiency by reducing the time expended for conducting the survey, thus allowing quicker return to the drilling of the borehole, or other necessary drilling rig operations. The digital camera can be utilized for surveying while traversing inside boreholes using any suitable wireline conveyance. Further, the digital camera surveying system avoids the surveying failures that may result in survey tools as a result of using photographic film. The digital camera survey system provides a reliable, time efficient method for surveying a borehole. Further, the digital camera survey system provides a relatively low cost method in comparison to alternative methods for measuring slant angle and borehole direction.

Implementations described herein are included to demonstrate particular aspects of the present disclosure. It should be appreciated by those of skill in the art that the implementations described herein merely represent exemplary implementation of the disclosure. Those of ordinary skill in the art should, in light of the present disclosure, appreciate that many changes can be made in the specific implementations described and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The implementations described hereinabove are meant to be illustrative only and should not be taken as limiting of the scope of the disclosure.

What is claimed is:

1. A digital camera survey system comprising:
a first housing;
a gyro compass with a rotatable member, wherein the gyro compass is utilized to determine a geographical direction; and
a digital camera disposed within the first housing, wherein the digital camera captures digital images of the gyro compass during surveying.

2. The system of claim 1, further comprising an inclinometer for measuring inclination, wherein the digital camera captures digital images of the inclinometer during surveying.

3. The system of claim 1, further comprising a lamp disposed within the first housing for illuminating the gyro compass.

4. The system of claim 1, further comprising an interface assembly, wherein the interface assembly provides a output port for communication with an external device.

5. The system of claim 4, wherein the output port is a USB port, mini USB port, or IEEE 1394.

6. The system of claim 1, further comprising a depth measurement tool for measuring the depth of the digital camera survey system, wherein a depth measurement is associated with each of the digital images.

7. The system of claim 1, wherein the digital images are captured at a predetermined time interval.

8. The system of claim 1, wherein the digital images are captured while continuously raising or lowering the digital camera survey system.

9. The system of claim 1, wherein the gyro compass is disposed within the first housing.

10. The system of claim 1, wherein the gyro compass is disposed in a second housing.

11. The system of claim 10, wherein the digital camera is positioned at a first end of the first housing, wherein the first end of the first housing is coupled to the second housing of the gyro compass.

12. The system of claim 11, further comprising an adapter secured to the first end of the first housing, wherein the adapter positions a lens of the digital camera toward the gyro compass.

13. The system of claim 1, further comprising a wireless communication device, wherein the wireless communication transmits the digital images to an external device.

14. A method surveying a borehole comprising:
activating a digital camera survey system, wherein the digital camera survey system comprises,
a housing,
a gyro compass with a rotatable member, wherein the gyro compass is utilized to determine a geographical direction, and
a digital camera disposed within the housing, wherein the digital camera captures digital images;
referencing on the surface the rotatable member of the gyro compass to determine a geographical direction;
lowering the digital camera surveying system into a borehole to survey the borehole; and
capturing a plurality of digital images of the gyro compass.

15. The method of claim 14, wherein the plurality of digital images captured include an inclinometer.

16. The method of claim 14, further comprising measuring the depth of the digital camera survey system, wherein depth measurements are time synchronized with the plurality of digital images.

17. The method of claim 15, further comprising measuring the depth of the digital camera survey system, wherein depth measurements are time synchronized with the plurality of digital images.

18. The method of claim 14, wherein the plurality of digital images are captured at a predetermined interval.

19. The method of claim 14, wherein the plurality of digital images are captured while continuously raising or lowering the digital camera survey system.

20. The method of claim 14, further comprising retrieving the digital camera survey system from the borehole; and connecting the digital survey camera system to an external device to retrieve the plurality of digital images.

21. The method of claim 17, further comprising retrieving the depth measurements and the plurality of digital images; and processing the plurality of digital images to produce a borehole survey providing a pathway of the borehole.
